(19) United States
(12) Patent Application Publication
(10) Pub. No.: US 2019/0024703 A1
(43) Pub. Date: Jan. 24, 2019

(54) STABILIZER LINK

(71) Applicants: HYUNDAI MOBIS CO., LTD., Seoul (KR); ILJIN CO., LTD., Gyeongju-si (KR)

(72) Inventors: Jin Won LEE, Yongin-si (KR); Yeong A CHEON, Seoul (KR); Woo Jeong OH, Seoul (KR); Kyoo Sung LEE, Daegu (KR)

(21) Appl. No.: 15/996,540

(22) Filed: Jun. 4, 2018

(30) Foreign Application Priority Data
Jul. 21, 2017 (KR) 10-2017-0092534

(51) Int. Cl. F16C 11/06

(52) U.S. Cl. CPC F16C 11/068

(57) ABSTRACT

A stabilizer link may include: a ball stud having a ball installed at the bottom thereof; a bearing member covering the ball, and providing grease to the outer circumferential surface of the ball; and a case having a housing groove in which the bearing member is mounted.

### CROSS-REFERENCES TO RELATED APPLICATION

This application claims priority from and the benefit of Korean Patent Application number 10-2017-0092534, filed on Jul. 21, 2017, which is hereby incorporated by reference for all purposes as if set forth herein.

### BACKGROUND

### Field

Exemplary embodiments relate to a stabilizer link, and more particularly, to a stabilizer link which is capable of smoothing a flow of grease, thereby improving the durability of a rotating or rocking ball stud.

### Discussion of the Background

The suspension system of a vehicle refers to a device that connects an axle and a vehicle body, and blocks vibration or shock from being directly transferred to the vehicle body, the vibration or shock being applied to the axle from the road during driving, thereby improving ride comfort while preventing a damage of the vehicle body. The suspension system includes a chassis spring for relieving shock applied from the road, a shock absorber for improving ride comfort by controlling free vibration of the chassis spring, and a stabilizer for preventing rolling of the vehicle.

The stabilizer includes a stabilizer bar which is elongated along the width direction of the vehicle body and supported by the vehicle body, and a stabilizer link which connects the stabilizer bar to a suspension arm such as a lower arm.

In the related art, the stabilizer link has a ball stud mounted in a case, and a ball of the ball stud is covered with POM (Polyoxymethylen) for smooth rotation or rocking of the ball stud. In order to prevent interference between the ball stud and the case during the rotation or rocking of the ball stud, the lower end portion of the ball stud needs to be subjected to special processing or formed in a perfect sphere shape. Furthermore, since grease is not smoothly supplied between the ball stud and the POM, lubrication performance may be degraded, and the case and the ball stud may come in direct contact with each other. In this case, the durability may be degraded. Therefore, there is a demand for a device capable of solving the problem.

The related art is disclosed in Korean Patent Registration No. 10-1500239 registered on Mar. 2, 2015 and entitled “Stabilizer link”.

The above information disclosed in this Background section is only for enhancement of understanding of the background of the invention and, therefore, it may contain information that does not constitute prior art.

### SUMMARY

Exemplary embodiments of the present invention provide a stabilizer link capable of smoothing a flow of grease, thereby improving the durability of a rotating or rocking ball stud.

In one embodiment, a stabilizer link may include: a ball stud having a ball installed at the bottom thereof; a bearing member covering the ball, and providing grease to the outer circumferential surface of the ball; and a case having a housing groove in which the bearing member is mounted.

The case may be formed of a plastic material.

The bearing member may include: a bearing body having an opened upper portion, and housing the ball therein; and a lubrication groove formed in the inner surface of the bearing body so as to guide a flow of grease.

The lubrication groove may include: a first lubrication groove formed in a top-to-bottom direction in the inner surface of the bearing body; and a second lubrication groove crossing the first lubrication groove, and formed in a circumferential direction in the inner surface of the bearing body.

The plurality of first lubrication grooves may be formed at predetermined intervals in the inner surface of the bearing body.

The bearing member may further include a protrusion protruding upward from the top of the bearing body so as to fix the ball.

The first lubrication groove may be formed in the inner surface of the protrusion.

The bottom portion of the bearing body may have a larger thickness than the side portion thereof.

The bearing body may have a grease pocket concavely formed in the bottom thereof, the grease pocket being isolated from the ball and containing grease.

The bearing body may have cut grooves formed in the top-to-bottom direction so as to be elastically coupled to the ball housed therein.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic partial cross-sectional view of a stabilizer link in accordance with an embodiment of the present invention.

FIG. 2 is an assembled perspective view schematically illustrating that a ball stud and a bearing member are coupled to each other in accordance with the embodiment of the present invention.

FIG. 3 is a schematic perspective view of the bearing member in accordance with the embodiment of the present invention.

FIG. 4 is a schematic cross-sectional view of the bearing member in accordance with the embodiment of the present invention.

FIG. 5 is a schematic cross-sectional view illustrating that the ball stud and the bearing member are coupled to each other in accordance with the embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Hereinafter, exemplary embodiments of the present invention will be described in more detail with reference to the accompanying drawings.

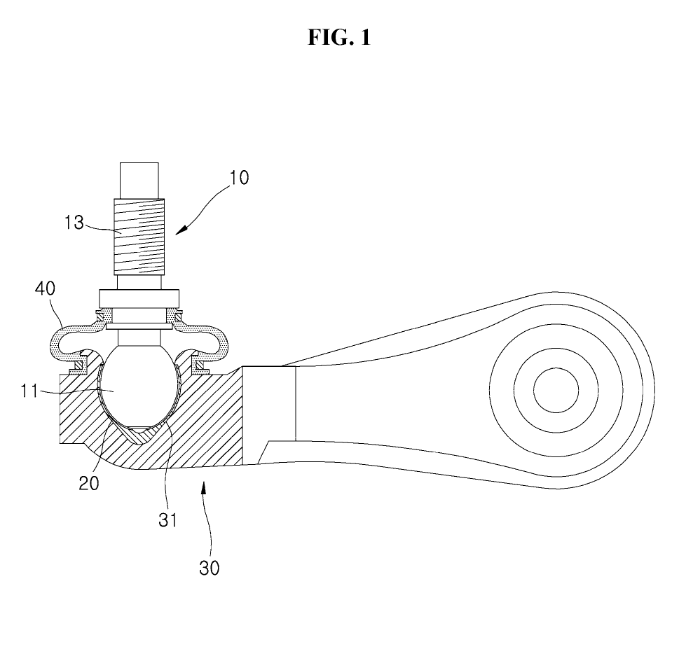

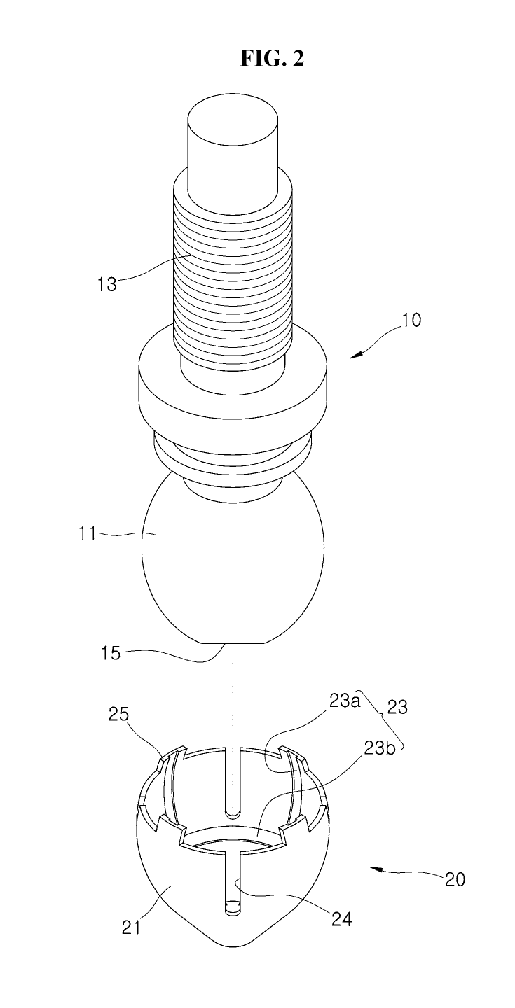

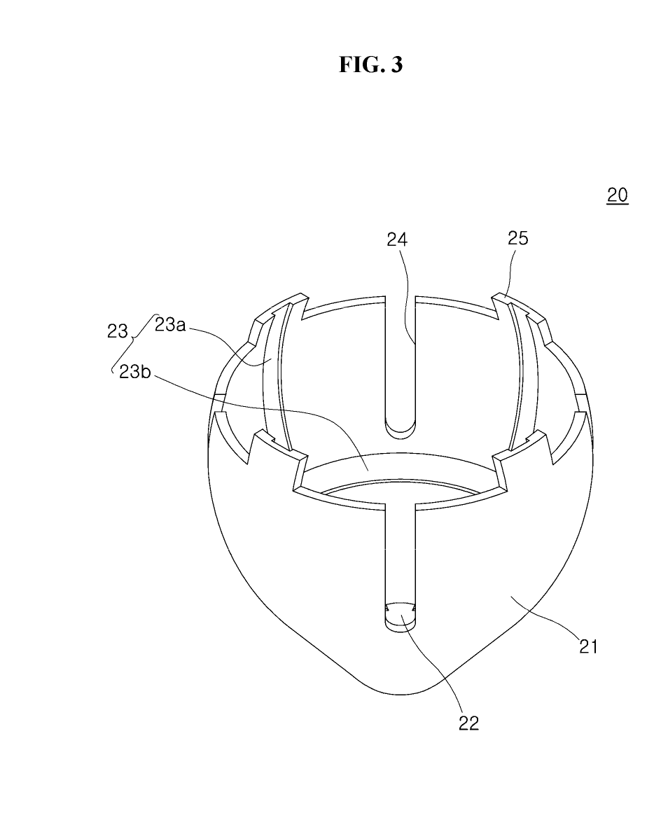

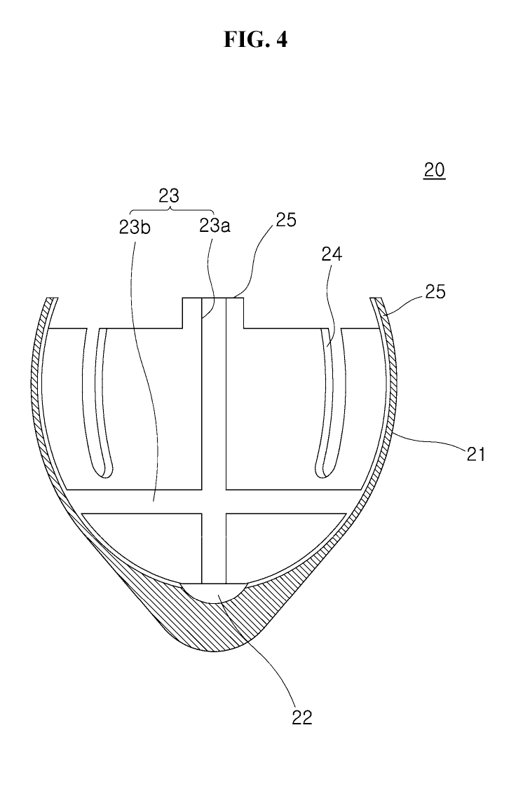

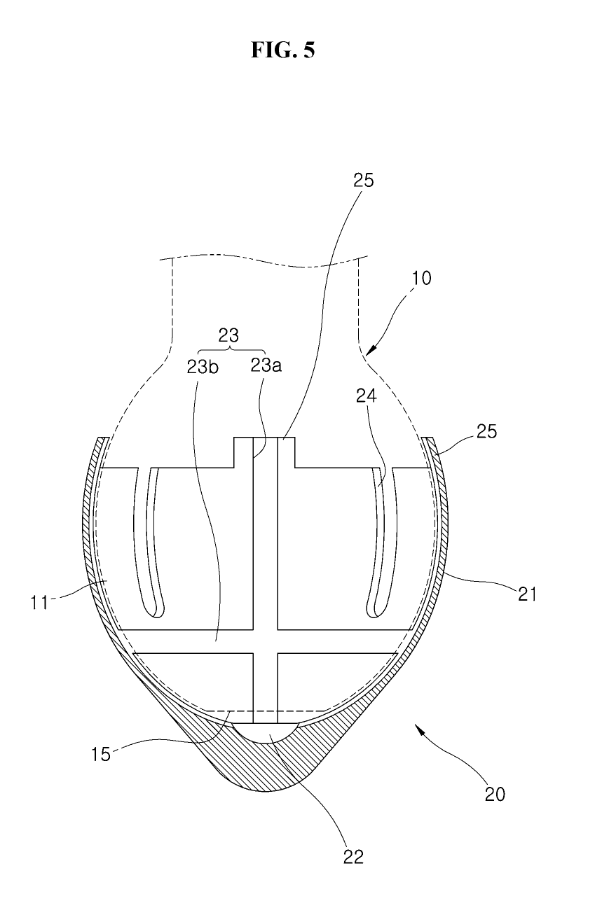

FIG. 1 is a schematic partial cross-sectional view of a stabilizer link in accordance with an embodiment of the present invention, FIG. 2 is an assembled perspective view schematically illustrating that a ball stud and a bearing member are coupled to each other in accordance with the embodiment of the present invention, FIG. 3 is a schematic perspective view of the bearing member in accordance with the embodiment of the present invention, FIG. 4 is a schematic cross-sectional view of the bearing member in accordance with the embodiment of the present invention, and FIG. 5 is a schematic cross-sectional view illustrating that the ball stud and the bearing member are coupled to each other in accordance with the embodiment of the present invention.

Referring to FIGS. 1 and 2, the stabilizer link in accordance with the embodiment of the present invention may include a ball stud 10, a bearing member 20 and a case 30. The ball stud 10 may have a ball 11 formed at the bottom thereof and a threaded portion 13 installed at the top thereof, the threaded portion having a screw thread formed thereon. The threaded portion 13 of the ball stud 10 may be screwed to a nut (not illustrated), such that the ball stud 10 is fixed to a stabilizer bar (not illustrated).

The ball 11 may be rotatably installed at an end (lower end based on FIG. 1) of the ball stud 10. The ball 11 may be rotatably or rockably housed in the bearing member 20, formed in a spherical shape as a whole, and have a flat bottom surface.

The bearing member 20 may cover the ball 11 of the ball stud 10, and provide grease to the outer circumferential surface of the ball 11. The bearing member 20 may rotatably or rockably house the ball 11. The bearing member 20 may include a bearing body 21, a lubrication groove 23 and a protrusion 25.

Referring to FIGS. 3 to 5, the upper portion of the bearing body 21 may be opened, and the ball 11 may be housed through the opened upper portion. The bearing body 21 may have an inner space for housing the ball 11. The bearing body 21 may have a plurality of cut grooves 24 formed in the circumferential direction thereof, such that the ball 11 is elastically coupled to the bearing member 20.

The diameter of the bearing body 21 in the circumferential direction may be set to a smaller value than the outer diameter of the ball 11. Thus, as the cut grooves 24 are spread, the ball 11 may be housed in the bearing body 21. When the ball 11 is housed in the bearing body 21, the bearing body 21 spread through the cut grooves 24 may be elastically compressed to prevent a separation of the ball 11.

The protrusion 25 may be formed at the opened upper portion of the bearing body 21 in order to fix the ball 11. The protrusion 25 may protrude from the opened upper portion of the bearing body 21 having a first lubrication groove 23a formed therein. The protrusion 25 may protrude in a curved shape along the outer curved surface of the bearing body 21 from the upper portion of the bearing body 21, in order to fix the ball 11 housed in the bearing body 21. The first lubrication groove 23a may be extended to the inner surface of the protrusion 25, such that grease is supplied to the ball 11 covered by the protrusion 25 through the first lubrication groove 23a.

The inner surface of the bearing body 21 may be coated with grease to smooth the rotation or rocking of the ball 11. Since the upper portion of the ball 11 of the ball stud 10 is covered by the protrusion 25, a separation of the ball 11 can be prevented.

The bottom portion (lower direction) of the bearing body 21 may have a larger thickness than the side portion (circumferential direction) thereof. That is, the bearing body 21 may be formed in an elliptical shape of which the bottom portion protrudes. Since the bottom portion of the bearing body 21 has a larger thickness than the side portion thereof, the bearing body 21 may have a space at the bottom thereof, in which a grease pocket 22 can be formed. That is, the inner surface of the bearing body 21 may be formed in a shape corresponding to the exterior of the ball 11, but the bottom portion of the bearing body 21 may have a larger thickness than the side portion thereof. Thus, the outer surface of the bearing body 21 may be formed not in a circular shape, but in an elliptical shape of which the bottom portion protrudes.

The grease pocket 22 for containing grease may be concavely formed in the bottom of the bearing body 21 so as to be isolated from the ball 11. The grease pocket 22 for containing grease may provide grease to a motion of the rotating or rocking ball 11 in the ball stud 10.

Since the grease pocket 22 is isolated from the ball 11 and blocked from contact with the ball 11, the rotation or rocking of the ball 11 may be smoothly performed. Furthermore, since the bottom surface 15 of the ball 11 is formed with a flat surface, contact between the ball 11 and the grease pocket 22 may be blocked.

The lubrication groove 23 may be formed in a check pattern on the inner surface of the bearing body 21, and concavely formed in the bearing body 21 so as to guide grease. The grease may be applied onto the outer circumferential surface of the ball 11 while flowing along the lubrication groove 23 according to a motion of the rotating or rocking ball 11. Therefore, the ball 11 may be sufficiently coated with the grease, and thus smoothly rotate or rock.

The lubrication groove 23 may include first and second lubrication grooves 23a and 23b. The first lubrication groove 23a may be formed in the top-to-bottom direction on the inner surface of the bearing body 21, and the second lubrication groove 23b may be formed in the circumferential direction (side-to-side direction) on the inner surface of the bearing body 21. The second lubrication groove 23b may cross the first lubrication groove 23a. The plurality of first and second lubrication grooves 23a and 23b may be formed at predetermined intervals in the bearing body 21. Thus, the lubrication groove 23 constituted by the plurality of first and second lubrication grooves 23a and 23b may be formed in a check pattern in the bearing body 21. In other words, the plurality of lubrication grooves 23 may be formed in the inner surface of the bearing body 21, such that grease can be smoothly supplied between the bearing body 21 and the ball 11.

The predetermined intervals at which the first and second lubrication grooves 23a and 23b are formed in the bearing body 21 and the widths of the first and second lubrication grooves 23a and 23b may be set in consideration of the state of grease applied onto the ball 11.

The case 30 may have a housing groove 31 serving as a housing space mounted in the bearing member 20. The housing groove 31 may be formed in a shape corresponding to the shape of the bearing member 20. Since the case 30 is formed of a plastic material, a weight reduction effect can be obtained. The case 30 may be integrated with the bearing member 20 through double-shot injection molding.

The stabilizer link in accordance with the embodiment of the present invention is may further include a dust cover 40. One side (lower side based on FIG. 1) of the dust cover 40 may be fixed to the case 30, and the ball stud 10 may be rotatably connected to the other side (upper side based on FIG. 1) of the dust cover 40. The dust cover 40 may seal the ball 11 of the ball stud 10 housed in the bearing member 20. The dust cover 40 may be rotatably connected to the ball stud 10, which makes it possible to prevent twists of the dust cover 40 when the ball stud 10 rotates or rocks. The dust cover 40 may be formed of an elastic material, and have a wrinkled structure.

The dust cover 40 may have O-rings formed at the top and bottom thereof, in order to prevent a leakage of grease.

In accordance with the embodiment of the present invention, grease can be provided to the ball stud 10 and thus smooth the rotation or rocking of the ball stud 10.

Furthermore, since grease smoothly flows through the lubrication grooves 23 of the bearing member 20, the durability can be improved.

Furthermore, since the bottom portion of the bearing member 20 is formed to such a thickness that the grease pocket 22 is formed, it is possible to avoid interference between the ball of the ball stud 10 and the bearing member 20.

Furthermore, since interference between the ball 11 of the ball stud 10 and the bearing member 20 can be avoided by the grease pocket 22, the ball 11 of the ball stud 10 does not need to be subjected to a separate process, but can be mounted in the bearing member 20.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A stabilizer link comprising:
a ball stud comprising a ball installed at a bottom thereof;
a bearing member configured to cover the ball, and to provide grease to an outer circumferential surface of the ball; and
a case comprising a housing groove in which the bearing member is mounted.

2. The stabilizer link of claim 1, wherein the case is formed of a plastic material.

3. The stabilizer link of claim 1, wherein the bearing member comprises:
a bearing body comprising an opened upper portion, and the opened upper portion is configured to house the ball therein; and
a lubrication groove formed in an inner surface of the bearing body to guide a flow of grease.

4. The stabilizer link of claim 3, wherein the lubrication groove comprises:
a first lubrication groove formed in a top-to-bottom direction in the inner surface of the bearing body; and
a second lubrication groove crossing the first lubrication groove, and formed in a circumferential direction in the inner surface of the bearing body.

5. The stabilizer link of claim 4, wherein a plurality of first lubrication grooves are formed at predetermined intervals in the inner surface of the bearing body.

6. The stabilizer link of claim 4, wherein the bearing member further comprises a protrusion configured to protrude upward from the top of the bearing body to fix the ball.

7. The stabilizer link of claim 6, wherein the first lubrication groove is formed in the inner surface of the protrusion.

8. The stabilizer link of claim 3, wherein a bottom portion of the bearing body has a larger thickness than a side portion thereof.

9. The stabilizer link of claim 8, wherein the bearing body has a grease pocket concavely formed in the bottom thereof, the grease pocket being isolated from the ball and containing grease.

10. The stabilizer link of claim 3, wherein the bearing body further comprises cut openings defined in a top-to-bottom direction so as to elastically couple the bearing body to the ball.
